(19) United States
(12) Patent Application Publication
(10) Pub. No.: US 2026/0210750 A1
(43) Pub. Date: Jul. 23, 2026

(54) RADIOMETRIC FILL LEVEL MEASUREMENT

(71) Applicant: Endress+Hauser SE+Co. KG, Maulburg (DE)

(72) Inventors: Viraj Chitale, Steinen (DE); Markus Franzke, Schwörstadt-Dossenbach (DE); Narcisse Michel Nzitchieu Gadeu, Maulburg (DE); Simon Weidenbruch, Lörrach (DE); Daniela Huber, Wehr (DE)

(21) Appl. No.: 19/140,059

(22) PCT Filed: Dec. 7, 2023
(86) PCT No.: PCT/EP2023/084663

§ 371 Date: Jun. 17, 2025

(30) Foreign Application Priority Data
Dec. 19, 2022 (DE) 10 2022 133 797.9

(51) Int. Cl. G01F 23/288; G01N 9/24; G01T 1/20

(52) U.S. Cl. CPC G01F 23/288; G01N 9/24; G01T 1/2018

(57) ABSTRACT

A constructively simplified detector for a radiometric measuring system, wherein the measuring system serves for determining density or fill level of a fill substance in a container, includes: a scintillator; a photomultiplier, which is optically connected with the scintillator such that it generates an electrical evaluation signal as a function of radioactive radiation intensity entering the scintillator; and an evaluation unit of the detector connected to the photomultiplier, which determines density or fill level of the fill substance based on the evaluation signal. The detector is distinguished by an optically and magnetically shielding housing, which shields at least the scintillator and the photomultiplier. As a result, a separate, magnetic shielding of the photomultiplier is unnecessary. In this way, the number of components and, thus, effort to produce the detector are reduced.

The invention relates to a simply constructed detector for radiometric fill level-or density measurement.

In automation technology, especially in process automation, measuring devices and measuring systems are often applied to serve for registering and/or influencing process variables. In such case, process variables include, among others, fill level, flow, pressure, temperature, pH value, redox potential and conductivity. Depending on process variable, various measuring principles are implemented in the measuring devices and measuring systems. Serving for influencing process variables are actuators, for instance valves or pumps, via which the flow of a liquid in a pipeline section or the fill level in a container can be changed. A large number of such measuring devices and measuring systems are manufactured and sold by the Endress+Hauser group of firms.

When, because of harsh conditions, other measuring principles, such as, for example, radar, are not suitable, then, above all, radiometric based measuring systems are applied for fill level measurement. In the case of the radiometric measuring principle, radioactive radiation is utilized. This can be, for example, gamma radiation from a cesium- or cobalt-source. Such passes from the source through a container containing a fill substance. After passage through the container, remaining radiation intensity is registered by a corresponding detector of the measuring system. For this, the detector is arranged on the opposite side of the container from the radiation source. Based on the intensity, or power, of the signal entering the detector, the fraction of the radiation originally coming from the radiation source is determined. Based on this transmitted fraction, in turn, the fill level of the fill substance in the container is determined. In such case, the transmitted fraction of the radioactive radiative power after passage through the container cannot be directly detected. Instead, the radioactive radiation is converted in the detector by a suitable material, firstly, into electromagnetic radiation in the optical spectral range. Only then can the radiative power be detected in the detector using a photomultiplier.

Materials, which have such a conversion property, are referred to as scintillating materials. Among others, polystyrene, polyvinyl-toluene and thallium doped sodium iodide are examples of such materials. Besides fill level, such measuring systems operating based on the radiometric measuring principle can, after corresponding calibration, also determine the density of the fill substance. Radiometric fill level-and density measurement systems are known from the state of the art. The basic functional principle is described, for example, in EP 2 208 031 B1.

In contrast with the scintillator and the evaluation unit, the photomultiplier is especially disturbance sensitive to magnetic fields, because of which the photomultiplier is separately shielded in the detector against such disturbing influences. This means extra structural, material and manufacturing costs.

An object of the invention, therefore, is to provide a radiometric measuring system detector for simplifying these aspects.

The invention achieves the object by a detector for a radiometric measuring system, comprising:
a scintillator,
a photomultiplier, which is optically connected with the scintillator in such a manner that it generates an electrical evaluation signal as a function of a radioactive radiation intensity entering the scintillator, and
an evaluation unit connected to the photomultiplier for determining density or fill level of a fill substance based on the evaluation signal.

In such case, the detector is distinguished by an optically and magnetically shielding housing, which shields, or completely encloses, at least the scintillator and the photomultiplier as well as, in given cases, supplementally, the evaluation unit. For this, the housing can be made of any magnetizable material, such as nickel, copper or iron or, especially, mild steel. By the design of the housing of the invention, a separate, magnetic shielding of the photomultiplier is unnecessary. In this way, the number of components and, thus, manufacturing effort, for the detector is reduced. In order to protect the magnetizeable material against weathering influences, it is additionally advantageous that the housing includes corrosion protection, especially a painting and/or a zinc coating.

The terminology, “unit”, in the context of the invention, means, in principle, any electronic circuits, which are provided for the particular application, such as, for example, for measurement signal processing or for interfacing. The particular unit can thus, depending on application, comprise corresponding analog circuits for producing, or processing, analog signals. The unit can, however, also comprise digital circuits, such as FPGAs, microcontrollers or storage media in cooperation with corresponding programs. In that case, the program is designed to perform the necessary method steps, or to apply the needed computer operations. In this context, different units can, within the scope of the invention, potentially also use a shared physical memory, or be operated by means of the same physical, digital circuit. On the other hand, it does not matter whether different electronic circuits within a unit are arranged on a shared circuit board or on a plurality of interconnected circuit boards.

A corresponding radiometric measuring system serving for fill level-and/or density measurement of fill substances in containers includes, besides the detector of the invention, additionally, a radioactive radiation source mountable in such a manner relative to the container that radioactive radiation is transmitted with a defined beam-cone, or lobe, toward the container. In such case, the detector is placed on the opposite side of the container from the radiation source in such a manner that the scintillator of the detector is located, at least partially, in the beam-cone of the radiation source.

The invention will now be explained in greater detail based on the appended drawing, the sole FIGURE of which shows as follows:

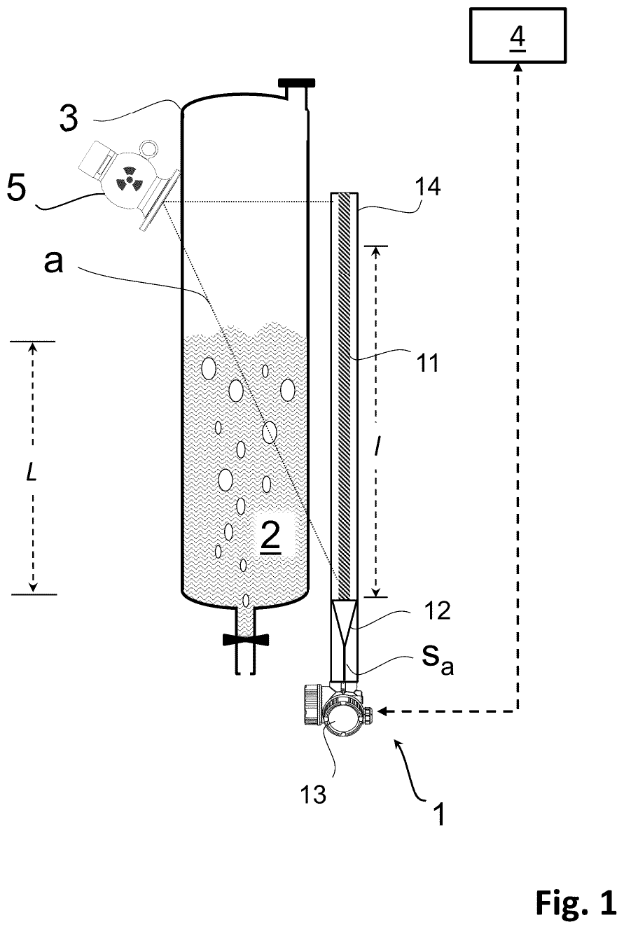

FIG. 1 a radiometric measuring system of the invention arranged at a container.

For understanding the invention, FIG. 1 shows a radiometric measuring system for industrial fill level measurement based on a detector 1 of the invention. Accordingly, FIG. 1 shows a container 3 of an industrial process plant. In such case, container 3 can contain, for example, crude petroleum as fill substance 2, which is undergoing a fractional distillation process. For controlling the process, the fill level L and/or density profile of the fill substance 2 is determined, wherein, due to the harsh process conditions, the radiometric measuring principle is used. For this, a radioactive radiation source 5 of the measuring system is so arranged and oriented at the container 3 that radioactive radiation is issued within a defined beam-cone a toward the container 3. In such case, the radiation source 5 is arranged in the embodiment of FIG. 1 at an upper end region of container 3 inclined downwards at about 45°. In this way, it is assured that the beam-cone a irradiates essentially the measuring range I of the container interior for measuring the fill level-, and density, profiles. Depending on height of the container 3, respectively, depending on which process is running, such measuring range I can be differently high, because of which the measuring system needs, in principle, to be individually adaptable, in order to fit the given case.

Detector 1 is arranged with respect to radiation source 5 oppositely at the container 3 in the beam-cone a of the radiation source 5. In such case, the detector 1 includes, in each case, all components needed for implementing the functional principle, thus, to produce, based on incoming, radioactive radiation, an electrical evaluation signal sₐ, which represents the power, or intensity, of the incoming radiation. Thus, a scintillator 11 of the detector 1 serves to convert the radioactive radiation incoming from the radiation source 5 into optical, or spectrally adjoining, radiation. For this, the scintillator 11 can, on the one hand, be based on organic scintillating material, such as polystyrene or polyvinyl-toluene. On the other hand, inorganic materials can be applied, which correspondingly have scintillating properties, such as thallium-doped sodium iodide or gadolinium-aluminum-gallium-garnet.

The radiation converted by the scintillator 11 into the optical range is then converted by a photomultiplier 12 into an evaluation signal sₐ representing the power, or the intensity, of the radiation incoming to the scintillator 11.

By the—vertical—orientation of the scintillator 11 toward the beam-cone a of the radiation source 5, the scintillator 11 receives the radioactive radiation after its passage through the fill substance 2 and through the gas phase located above the fill substance in the container interior. Thus, the intensity of the received radiation—relative to the starting intensity at the radiation source 5—depends essentially on the fill level L of the fill substance 1 as well as on its density: When, depending on the fill level L, fill substance 2 is located in the beam path between the radiation source 5 and the scintillator 11, then the intensity of the incoming, radioactive radiation lessens correspondingly, significantly, or measurably. In this way, the evaluation signal sₐ of the photomultiplier 12 represents the radiation intensity incoming to the scintillator 11.

In order to determine the density and/or the fill level L based on the evaluation signal sₐ, a correspondingly designed evaluation unit 13 of the detector 1 is provided. As shown in FIG. 1, the photomultiplier 12 and the evaluation unit 13 are correspondingly electrically contacted for this. Simultaneously, the power supply of the photomultiplier 12 by the evaluation unit 13 is assured via this contact.

Radiation source 5 and detector 1 can either be directly mounted to the container 3, or indirectly associated therewith via correspondingly freestanding supports. As shown in FIG. 1, the evaluation unit 13 of the measuring system can for controlling the process supplementally be connected to a superordinated unit 4, such as e.g., a local process control system or a decentral server system, via a separate interface unit, such as, for instance, “4-20 mA”, “PROFIBUS”, “HART”, or “Ethernet”. In this way, the measured density-, or fill level value L, can be transmitted, in order, for example, to control heating elements or possible supply lines to the container 3. However, also other information concerning general operating state of the measuring system can be communicated.

In the case of the embodiment of the detector 1 of the invention shown in FIG. 1, the evaluation unit 12 is arranged constructively in an independent housing part. This housing part, in turn, adjoins the lower end region of a housing 14, in which the scintillator 11 and the photomultiplier 12 are arranged. In contrast with the showing of FIG. 1, another option provides that the housing part of the evaluation unit 12 adjoins the upper end region of housing 14. Moreover, it is an option, in contrast to the view of FIG. 1, that the evaluation unit 13 is arranged in the same housing 14 as the scintillator 11 and the photomultiplier 12.

In order that the evaluation signal sₐ represents exclusively the power, or the intensity, of the radioactive radiation incoming to the scintillator 11, it is necessary that the photomultiplier 12 be shielded from possible magnetic disturbance fields. At the same time, the photomultiplier 12 and the scintillator 11 must not be influenced by environmental light. Therefore, the housing 14, in which the scintillator 11 and the photomultiplier 12 are arranged together, is so designed that it shields the scintillator 11 and the photomultiplier 12 both from optical radiation, as well as also from magnetic fields. For this, the housing 14 can, in principle, be made from any magnetizable metal, such as, for example, iron, cobalt or nickel. In this way, in contrast to the state of the art, a separate, magnetic shielding of the photomultiplier 12 is unnecessary. Especially advantageous in this connection is mild steel as housing material, due to its mechanical robustness. In this way, the housing 14 protects not only optically and magnetically, but also as regards mechanical shock, or impact, resistance.

Especially when using easily rusting mild steel as an option, the housing 14 is provided with an external painting or a sacrificial anode to protect the housing against weathering influences, such as moisture. Regarding weathering influences, the housing part of the evaluation unit 12 illustrated in FIG. 1 as well as other possible lids or closures are, moreover, preferably, constructed in such a manner that the housing 14, externally and entirely, closes the scintillator 11 and the photomultiplier 12 media tightly. In such case, such housing part, possible cover, closures or corresponding parts of the housing 14, which are not located at the height of the photomultiplier 12, can be made of a nonmagnetically shielding material, as long as the magnetic shielding is assured. cl List of Reference Characters
1 detector
2 fill substance
3 container
4 superordinated unit
5 radioactive radiation source
11 scintillator
12 photomultiplier
13 evaluation unit
14 optically and magnetically shielding housing
a beam-cone
L fill level
I measuring range
sₐ evaluation signal

1-5. (canceled)

6. A detector for a radiometric measuring system for determining a density or a fill level of a fill substance in a container, the detector comprising:
a scintillator;
a photomultiplier optically connected with the scintillator, wherein the photomultiplier is configured to generate an electrical evaluation signal as a function of a radioactive radiation intensity entering the scintillator;
an evaluation unit connected to the photomultiplier configured to determine the density or fill level of the fill substance based on the evaluation signal; and
an optically and magnetically shielding housing configured to shield at least the scintillator and the photomultiplier.

7. The detector as claimed in claim 6, wherein the housing additionally shields the evaluation unit.

8. The detector as claimed in claim 6, wherein the housing is made of a magnetizable material.

9. The detector as claimed in claim 8, wherein the magnetizable material is mild steel.

10. The detector as claimed in claim 6, wherein the housing includes corrosion protection.

11. The detector as claimed in claim 10, wherein the corrosion protection is a paint and/or zinc coating.

12. A radiometric measuring system for determining a fill level of a fill substance located in a container, the measuring system comprising:
a radioactive radiation source arrangeable relative to the container such that radioactive radiation is transmitted within a beam-cone toward the container, and
the detector according to claim 6 arranged on an opposite side of the container from the radiation source such that the scintillator is located, at least partially, in the beam-cone.
